(19) United States
(12) Patent Application Publication
(10) Pub. No.: US 2026/0006322 A1
(43) Pub. Date: Jan. 1, 2026

(54) ELECTRONIC DEVICE

(71) Applicant: CANON KABUSHIKI KAISHA, Tokyo (JP)

(72) Inventors: Yuki KUROSAWA, Tokyo (JP); Tomoaki TAKAHASHI, Kanagawa (JP)

(21) Appl. No.: 19/233,390

(22) Filed: Jun. 10, 2025

(30) Foreign Application Priority Data
Jun. 27, 2024 (JP) 2024-103940

(51) Int. Cl. H04N 23/667; H04N 23/63

(52) U.S. Cl. CPC H04N 23/667; H04N 23/632

(57) ABSTRACT

An electronic device according to the present disclosure includes a processor, and a memory storing a program which, when executed by the processor, causes an electronic device to execute a control process of performing control to display an image stored in a storage on a display, wherein, in a case where a first user operation of switching an image to be displayed on the display is executed with a still image being displayed on the display, an image to be displayed on the display is switched from the still image to a moving image in the control process, and wherein, in a case where the first user operation is executed with a moving image being displayed on the display, the image to be displayed on the display is switched from the moving image to a still image in the control process.

### BACKGROUND

### Field of the Technology

The present disclosure relates to an electronic device, and particularly to content display control.

### DESCRIPTION OF THE RELATED ART

With an improvement in a shutter speed of a camera and an increase in a capacity of a recording medium, the number of images to be captured (recorded) has increased, which leads to more scenes where a user selects and confirms any image from many captured images. It is a user's labor to select any image from many images. As a function of reducing such a labor, a function of switching an image to be displayed to a previous image by a predetermined number ahead, a function of switching an image to be displayed between a plurality of images satisfying a predetermined condition, and the like have been proposed. Japanese Patent Laid-Open No. 2007-53414 discloses a function of switching an image to be displayed to a head image of a folder different from a folder of an image which is being displayed.

However, the above-described functions of the related art may not be able to reduce a user's labor. For example, in the function disclosed in Japanese Patent Laid-Open No. 2007-53414, when one of still image capturing and moving image capturing is followed by the other and both the still image and the moving image are checked, the user's labor may not be reduced.

### SUMMARY

The present disclosure provides a technique capable of reducing a user's labor for confirming an image.

An electronic device according to the present disclosure includes a processor, and a memory storing a program which, when executed by the processor, causes an electronic device to execute a control process of performing control to display an image stored in a storage on a display, wherein, in a case where a first user operation of switching an image to be displayed on the display is executed with a still image being displayed on the display, an image to be displayed on the display is switched from the still image to a moving image in the control process, and wherein, in a case where the first user operation is executed with a moving image being displayed on the display, the image to be displayed on the display is switched from the moving image to a still image in the control process.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are external views illustrating a digital camera.

FIG. 2 is a block diagram illustrating the digital camera.

FIGS. 3A and 3B are schematic diagrams illustrating screens in a single display mode.

FIGS. 3C and 3D are schematic diagrams illustrating screens in a multiple display mode.

FIG. 4 is a schematic diagram illustrating stored data.

FIG. 5 is a schematic diagram illustrating catalog data.

FIG. 6A is a flowchart illustrating a catalog data process.

FIG. 6B is a flowchart illustrating a catalog data generation process.

FIG. 6C is a flowchart illustrating a catalog data reading process.

FIG. 6D is a flowchart illustrating a catalog data updating process.

FIG. 7A is a flowchart illustrating an imaging mode process.

FIG. 7B is a flowchart illustrating a still image capturing process.

FIG. 7C is a flowchart illustrating a moving image capturing process.

FIG. 7D is a flowchart illustrating a still image storing process.

FIG. 7E is a flowchart illustrating a moving image storing process.

FIG. 8A is a flowchart illustrating a reproduction mode process.

FIG. 8B is a flowchart illustrating an image jump feeding process.

FIG. 8C is a flowchart illustrating a process of switching between a still image and a moving image.

FIG. 8D is a flowchart illustrating a process of switching an image to a moving image.

FIG. 8E is a flowchart illustrating a process of switching an image to a still image.

FIGS. 9A and 9B are schematic diagrams illustrating transitions of a current image.

FIGS. 10A and 10B are schematic diagrams illustrating transition of a current image.

FIG. 11 is a schematic diagram illustrating transition of a current image.

FIG. 12 is a schematic diagram illustrating transition of a current image.

### DESCRIPTION OF THE EMBODIMENTS

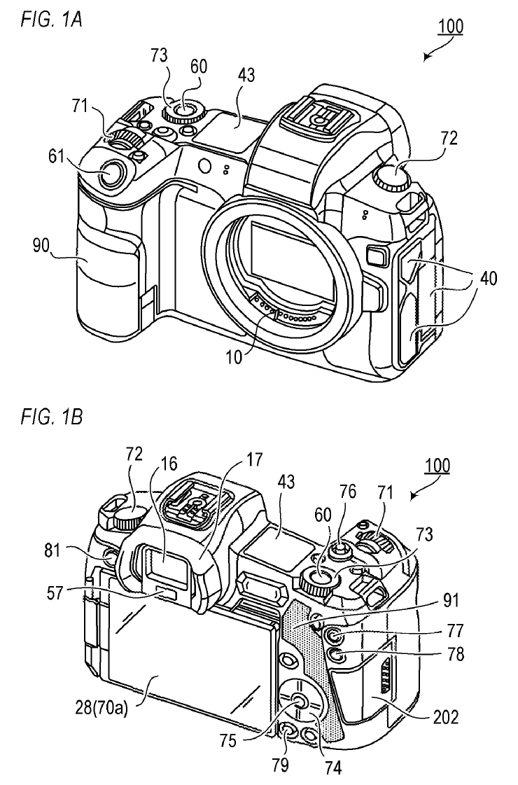

Embodiments of the present disclosure will be described. FIGS. 1A and 1B are external views illustrating a digital camera 100 (imaging device) as an example of an electronic device to which the present disclosure can be applied. FIG. 1A is a front perspective view illustrating the digital camera 100 and FIG. 1B is a rear perspective view illustrating the digital camera 100.

A display unit 28 is a display unit provided on the back surface of the digital camera 100 and displays an image and various types of information. A touch panel 70a can detect a touch operation on a display surface (touch operation surface) of the display unit 28. An outer finder display unit 43 is a display unit provided on the upper surface of the digital camera 100 and displays various setting values of the digital camera 100 including a shutter speed and an aperture. A shutter button 61 is an operation member for giving an imaging instruction. An imaging mode selection button 60 is an operation button for switching a set imaging mode among a plurality of imaging modes in the imaging mode. A terminal cover 40 is a cover that protects a connector (not illustrated) with a connection cable or the like that connects the digital camera 100 to an external device.

A main electronic dial 71 is a rotating operation member. By turning the main electronic dial 71, a setting value such as a shutter speed or an aperture can be executed. A power switch 72 is an operation member for switching between ON and OFF of a power supply of the digital camera 100. A sub-electronic dial 73 is a rotating operation member. By turning the sub-electronic dial 73, movement of a selection frame (cursor), image feeding, or the like can be executed. A four-direction key 74 is configured to be pressable at each of up, down, left, and right portions and a process corresponding to a pressed portion of the four-direction key 74 can be executed. The four-direction key 74 includes up, down, left, and right buttons respectively corresponding to up, down, left, and right portions. A SET button 75 is a push button and is mainly used to determine a selection item.

A moving image button 76 is used for an instruction to start or stop moving image capturing (recording). An AE lock button 77 is a push button. By pressing the AE lock button 77 in an imaging standby state, an exposure state can be fixed. An enlargement button 78 is an operation button for switching between ON and OFF of an enlargement mode in live view display (LV display) of an imaging mode. By turning ON the enlargement mode and then operating the main electronic dial 71, the live view image (LV image) can be enlarged or reduced. In a reproduction mode, the enlargement button 78 functions as an operation button for enlarging a reproduction image or increasing its enlargement ratio. A reproduction button 79 is an operation button for switching between the imaging mode and the reproduction mode. During the imaging mode, the mode shifts to the reproduction mode by pressing the reproduction button 79, and a latest image among images recorded in a recording medium 200 (to be described below) can be displayed on the display unit 28. During the reproduction mode, a mode can be switched to the imaging mode by operating (a half-press or a full-press) the shutter button 61. The operation mode may be switched between the imaging mode and the reproduction mode by operating a mode changeover switch (not illustrated).

A menu button 81 is a push button used to execute an instruction operation of displaying a menu screen. When the menu button 81 is pressed, a menu screen on which various settings can be executed is displayed on the display unit 28. A user can execute various settings instinctively by using the menu screen displayed on the display unit 28, the four-direction key 74, and the SET button 75.

A communication terminal 10 is a communication terminal that causes the digital camera 100 to execute communication with a lens unit 150 (detachable as will be described below) side. An eyepiece unit 16 is an eyepiece unit of the eyepiece finder 17 (viewing-type finder). A user can view a video displayed on an internal electric view finder (EVF) 29 (to be described below) through the eyepiece unit 16. An eyepiece detection unit 57 is an eyepiece detection sensor that detects whether an eye of the user (a person who executes imaging) approaches the eyepiece unit 16. A lid 202 is a lid of a slot that stores a recording medium 200 (to be described below). A grip unit 90 is a holding unit formed into a shape in which the user can easily grip the grip unit 90 with the right hand when the user holds up the digital camera 100. The shutter button 61 and the main electronic dial 71 are located at positions where the user can operate the shutter button 61 and the main electronic dial 71 with the index finger of the right hand in a state in which the user holds the digital camera 100 while gripping the grip unit 90 with the little finger, the ring finger, and the middle finger of the right hand. In the same state, the sub-electronic dial 73 is located at a position where a user can operate the sub-electronic dial 73 with the thumb finger of the right hand. A thumb rest unit 91 (thumb standby position) is a grip member provided on the back side of the digital camera 100 at a position where the thumb of the right hand gripping the grip unit 90 is easily placed without operating any operation member. The thumb rest unit 91 is configured with a rubber member for enhancing holding power (gripping feeling).

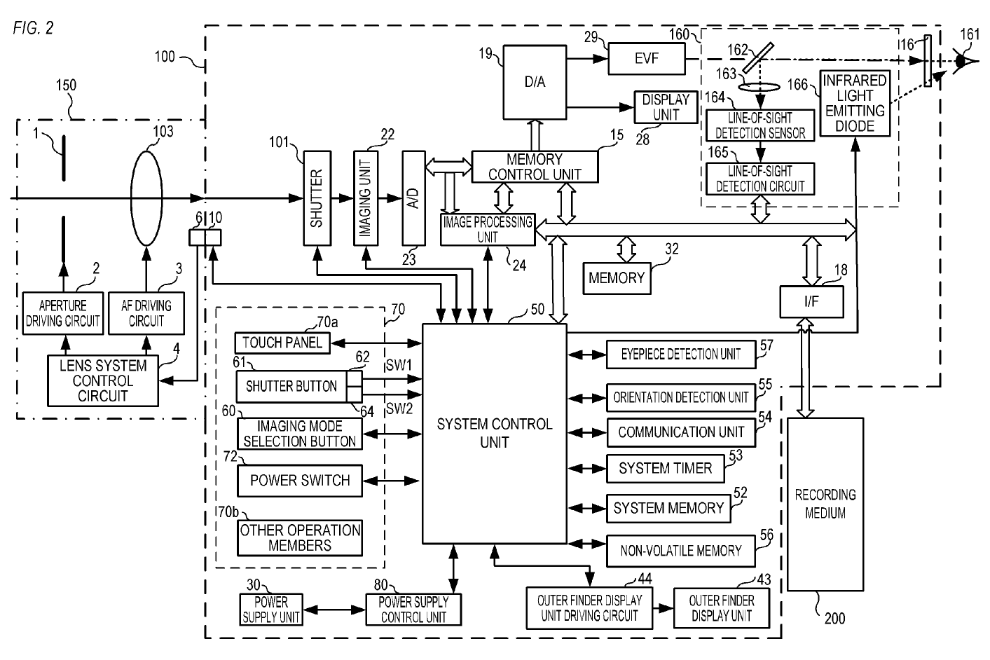

FIG. 2 is a block diagram illustrating a configuration example of the digital camera 100. The lens unit 150 is a lens unit on which an interchangeable imaging lens is mounted. A lens 103 is usually configured with a plurality of lenses, but only one lens in a simplified manner is illustrated in FIG. 2. A communication terminal 6 is a communication terminal which causes the lens unit 150 to communicate with the digital camera 100 side. The communication terminal 10 is a communication terminal that causes the digital camera 100 to communicate with the lens unit 150 side. The lens unit 150 communicates with a system control unit 50 via the communication terminals 6 and 10. The lens unit 150 executes controlling an aperture 1 via an aperture driving circuit 2 by a lens system control circuit 4. The lens unit 150 executes focusing by displacing a position of the lens 103 via an AF driving circuit 3 by the lens system control circuit 4.

A shutter 101 is a focal plane shutter that can freely control an exposure time of an imaging unit 22 under the control of the system control unit 50.

The imaging unit 22 is an imaging element (image sensor) configured with a CCD, a CMOS element, or the like that converts an optical image into an electrical signal. The imaging unit 22 may include an imaging-surface phase-difference sensor that outputs defocus amount information to the system control unit 50. An A/D converter 23 converts an analog signal output from the imaging unit 22 into a digital signal.

An image processing unit 24 executes a predetermined process (such as pixel interpolation, a resizing process such as reduction, or a color conversion process) on data from an A/D converter 23 or data from a memory control unit 15. The image processing unit 24 executes predetermined arithmetic processing by using captured image data, and the system control unit 50 executes exposure control and distance measurement control based on a calculation result obtained by the image processing unit 24. Accordingly, through-the-lens (TTL) type autofocus (AF) processing, auto exposure (AE) processing, flash pre-emission (EF) processing, and the like are executed. The image processing unit 24 executes predetermined arithmetic processing by using the captured image data and executes TTL-type auto white balance (AWB) processing based on the obtained calculation result.

The memory control unit 15 controls transmission and reception of data among the A/D converter 23, the image processing unit 24, and a memory 32. Output data from the A/D converter 23 is written on the memory 32 via the image processing unit 24 and the memory control unit 15. Alternatively, the output data from the A/D converter 23 is written on the memory 32 via the memory control unit 15 and without being involved in the image processing unit 24. The memory 32 stores image data which is obtained by the imaging unit 22 and is converted into digital data by the A/D converter 23 and image data to be displayed on the display unit 28 or the EVF 29. The memory 32 has a storage capacity which is sufficient for storing a predetermined number of still images and a moving image and a voice at a predetermined time.

The memory 32 also serves as a memory (video memory) for image display. A D/A converter 19 converts image data for display stored in the memory 32 into an analog signal and supplies the analog signal to the display unit 28 or the EVF 29. In this way, the image data for display that is written on the memory 32 is displayed by the display unit 28 or the EVF 29 via the D/A converter 19. Each of the display unit 28 and the EVF 29 is a display such as an LCD or an organic EL and executes display corresponding to an analog signal from the D/A converter 19. By causing the D/A converter 19 to convert digital signals A/D-converted by the A/D converter 23 and accumulated in the memory 32 into analog signals and sequentially transferring the analog signals and displaying the analog signals on the display unit 28 or the EVF 29, it is possible to execute live view display (LV). Hereinafter, an image displayed in the live view display is referred to as a live view image (LV image).

The system control unit 50 is a control unit including at least one processor and/or at least one circuit, and controls the entire digital camera 100. The system control unit 50 serves as a processor and also a circuit. The system control unit 50 implements each process according to an embodiment to be described below by executing a program recorded in a non-volatile memory 56. The system control unit 50 also executes display control by controlling the memory 32, the D/A converter 19, the display unit 28, the EVF 29, and the like.

A system memory 52 is, for example, a RAM. The system control unit 50 loads constants, variables, programs read from the non-volatile memory 56, and the like for an operation of the system control unit 50 on the system memory 52.

The non-volatile memory 56 is an electrically erasable and recordable memory and is, for example, an EEPROM. In the non-volatile memory 56, the constants, the programs, and the like for operations of the system control unit 50 are recorded. The programs as used herein are programs for executing various flowcharts to be described below according to the embodiment.

A system timer 53 is a timer unit that counts time used for various controls and time of an embedded clock.

A communication unit 54 transmits and receives a video signal and a voice signal to and from an external device connected wirelessly or via a wired cable. The communication unit 54 can also be connected to a wireless local area network (LAN) and the Internet. The communication unit 54 can also communicate with an external device through Bluetooth (registered trademark) or Bluetooth Low Energy. The communication unit 54 can transmit an image (including an LV image) captured by the imaging unit 22 and an image recorded on the recording medium 200 and can receive image data and other various types of information from an external device.

An orientation detection unit 55 detects an orientation of the digital camera 100 with respect to the direction of gravity. Based on the orientation detected by the orientation detection unit 55, it can be determined whether an image captured by the imaging unit 22 is an image captured with the digital camera 100 held horizontally or an image captured with the digital camera 100 held vertically. The system control unit 50 can add or rotate direction information corresponding to the orientation detected by the orientation detection unit 55 to an image file of the image captured by the imaging unit 22 to record the image. An acceleration sensor, a gyro sensor, or the like can be used as the orientation detection unit 55. A movement of the digital camera 100 (whether the digital camera 100 is panning, tilting, rolling, lifting, stationary, or the like) can also be detected using an acceleration sensor or a gyro sensor that is the orientation detection unit 55.

The eyepiece detection unit 57 is an eyepiece detection sensor that detects approach (eye approach) and separation (eye separation) of an eye (object) 161 (approach detection) with respect to the eyepiece unit 16 of the eyepiece finder 17 (hereinafter simply referred to as a “finder”). The system control unit 50 switches between display (display state) and non-display (non-display state) of the display unit 28 and the EVF 29 according to a state detected by the eyepiece detection unit 57. More specifically, in a case where at least the imaging standby state is established, and a switching setting for a display destination is set to automatic switching, while an eye is not approached, the display is turned on with the display destination set as the display unit 28, and the EVF 29 executes non-display. While an eye is approached, the display is turned on with the display destination set as the EVF 29, and the display unit 28 executes non-display. For example, an infrared proximity sensor can be used as the eyepiece detection unit 57, and the approach of any object to the eyepiece unit 16 of the finder 17 embedding the EVF 29 can be detected. When an object has approached, infrared light emitted from a light-emitting unit (not illustrated) of the eyepiece detection unit 57 is reflected from the object and is received by a light-receiving unit (not illustrated) of an infrared proximity sensor. A distance by which the object approaches from the eyepiece unit 16 (approach distance) can also be determined based on an amount of received infrared light. In this way, the eyepiece detection unit 57 executes an approach distance to detect a proximity distance of the object to the eyepiece unit 16. When an object which approaches the eyepiece unit 16 within a predetermined distance is detected in the non-eyepiece state (non-approach state), it is detected that the eye approaches. When the object of which the approach is detected is separated in the eyepiece state (approach state), it is detected that the eye is separated. A threshold for detecting eye approach and a threshold for detecting eye separation may be set to be different by providing, for example, a hysteresis. After the eye approach is detected, the eyepiece state is assumed until the eye separation is detected. After the eye separation is detected, the non-eyepiece state is assumed until the eye approach is detected. The infrared proximity sensor is exemplary, and another sensor may be adopted as the eyepiece detection unit 57 as long as the sensor can detect a state that can be regarded as eye approach.

Various setting values of the camera including a shutter speed and an aperture are displayed on an outer finder display unit 43 via an outer finder display unit driving circuit 44.

A power supply control unit 80 includes a battery detection circuit, a DC-DC converter, and a switch circuit that switches a block to be electrified, and detects whether a battery is mounted, a type of battery, a remaining battery level, or the like. The power supply control unit 80 controls the DC-DC converter based on a result of the detection and an instruction from the system control unit 50, and supplies a required voltage to units including the recording medium 200 for a necessary period of time. A power supply unit 30 is a primary battery such as an alkaline battery or a lithium battery, a secondary battery such as a NiCd battery, a NiMH battery, or a lithium ion battery, an AC adapter, or the like.

A recording medium I/F 18 is an interface with the recording medium 200 such as a memory card or a hard disk. The recording medium 200 is a recording medium such as a memory card on which a captured image is recorded, and is configured with a semiconductor memory, a magnetic disk, or the like.

An operation unit 70 is an input unit that receives an operation from a user (user operation) and is used for inputting various operation instructions to the system control unit 50. As illustrated in FIG. 2, the operation unit 70 includes a shutter button 61, an imaging mode selection button 60, a power switch 72, a touch panel 70a, and other operation members 70b. The other operation members 70b include a main electronic dial 71, a sub-electronic dial 73, a four-direction key 74, a SET button 75, the moving image button 76, the AE lock button 77, the enlargement button 78, the reproduction button 79, and the menu button 81.

The shutter button 61 includes a first shutter switch 62 and a second shutter switch 64. The first shutter switch 62 is turned ON during an operation of the shutter button 61, that is, a so-called half push (imaging preparation instruction), to generate a first shutter switch signal SW1. The system control unit 50 starts the imaging preparation operation such as autofocus (AF) processing, automatic exposure (AE) processing, automatic white balance (AWB) processing, or flash pre-emission (EF) processing by the first shutter switch signal SW1. The second shutter switch 64 is turned ON by completion of the operation of the shutter button 61, that is, a so-called full push (imaging instruction), to generate a second shutter switch signal SW2. The system control unit 50 starts a series of imaging processing operations from reading a signal from the imaging unit 22 to writing a captured image as an image file on the recording medium 200, by the second shutter switch signal SW2.

The imaging mode selection button 60 can switch an imaging mode of the digital camera 100 in the imaging mode. In the imaging mode, whenever an operation (pressing operation) is executed with the imaging mode selection button 60, the system control unit 50 sequentially switches the set imaging mode among the plurality of imaging modes. The plurality of imaging modes include an automatic imaging mode, an automatic scene determination mode, a manual mode, an aperture priority mode (Av mode), a shutter speed priority mode (Tv mode), and a program AE mode (P mode). There are also various scene modes and custom modes serving as imaging settings for each imaging scene. A user can directly switch an imaging mode to one of the modes with the imaging mode selection button 60. Alternatively, after temporarily switching to the list screen of the imaging modes with the imaging mode selection button 60, the imaging mode may be selectively switched to one of the plurality of displayed modes using another operation member. The set imaging mode may be switched between a still-image imaging mode and a moving-image imaging mode in response to an operation of the imaging mode selection button 60. In the case of the still-image imaging mode, a still image is recorded in response to an operation of the shutter button 61. In the case of the moving-image imaging mode, recording of a moving image is started or ended in response to an operation of the shutter button 61.

The touch panel 70a is a touch sensor that detects any of various touch operations on a display surface of the display unit 28 (an operation surface of the touch panel 70a). The touch panel 70a and the display unit 28 can be integrated. For example, the touch panel 70a is configured so that transmittance of light does not hinder display of the display unit 28, and is attached to an upper layer of the display surface of the display unit 28. Input coordinates on the touch panel 70a are associated with display coordinates on the display surface of the display unit 28. Accordingly, it is possible to provide a graphical user interface (GUI) configured as if the user can directly operate a screen displayed on the display unit 28.

A line-of-sight detection block 160 (an eye tracking unit or an eye tracker) is a block that detects whether the user whose eye approaches the eyepiece unit 16 is looking at the EVF 29 or a line of sight indicating which position the user is looking at when the user is looking at the EVF 29. The line-of-sight detection block 160 includes a dichroic mirror 162, an imaging lens 163, a line-of-sight detection sensor 164, an infrared light emitting diode 166, and a line-of-sight detection circuit 165.

The infrared light emitting diode 166 is a light-emitting element and irradiates the eyeball (eye) 161 of the user whose eye approaches the eyepiece unit 16 with infrared light. The infrared light emitted from the infrared light emitting diode 166 is reflected from an eyeball (eye) 161, and the infrared reflected light arrives at the dichroic mirror 162. The dichroic mirror 162 reflects only infrared light and transmits visible light. The infrared reflected light of which an optical path is changed forms an image on the imaging surface of the line-of-sight detection sensor 164 via the imaging lens 163. The imaging lens 163 is an optical member included in a line-of-sight detection optical system. The line-of-sight detection sensor 164 includes an imaging device such as a CCD image sensor. The line-of-sight detection sensor 164 photoelectrically converts the incident infrared reflected light into an electrical signal and outputs the electrical signal to the line-of-sight detection circuit 165. The line-of-sight detection circuit 165 includes at least one processor, detects a line-of-sight position of the user from an image or a movement of eyeball (eye) 161 of the user based on an output signal of the line-of-sight detection sensor 164, and outputs detection information to the system control unit 50.

In the embodiment, the line-of-sight detection block 160 is used to detect a line of sight according to a method referred to as a corneal reflection method. The corneal reflection method is a method of detecting a direction and a position of a line of sight from a positional relationship between reflected light obtained by reflecting infrared light emitted from the infrared light emitting diode 166 from the eyeball (eye) 161 (in particular, a cornea) and the pupil of the eyeball (eye) 161. In addition, there is a method of detecting various directions and positions of the line of sight, such as a method called a scleral reflection method in which a difference in light reflectance between the iris and the white of the eye is used. A line-of-sight detection method other than the foregoing methods may be used as long as a direction and a position of a line of sight can be detected according to the method. In the embodiment, the description has been given assuming that the light-emitting unit and the light-receiving unit of the eyepiece detection unit 57 are separate devices from the infrared light emitting diode 166 and the line-of-sight detection sensor 164 described above. However, the present disclosure is not limited thereto and the light-emitting unit of the eyepiece detection unit 57 may also serve as the infrared light emitting diode 166, and the light-receiving unit may also serve as the line-of-sight detection sensor 164.

The system control unit 50 can detect the following operation or state based on an output from the line-of-sight detection block 160.

· A line of sight of the user whose eye approaches the eyepiece unit 16 is newly input (detected). That is, start of a line-of-sight input.

· There is a line-of-sight input of the user whose eye approaches the eyepiece unit 16.

· A state in which the user whose eye approaches the eyepiece unit 16 is gazing.

· A line of sight input by the user whose eye approaches the eyepiece unit 16 is removed. That is, the end of the line-of-sight input.

· A state in which the user whose eye approaches eyepiece unit 16 does not input any line of sight.

The gaze described herein means that the user is continuously gazing at substantially the same position over a certain period of time. In the determination regarding whether the user is gazing, for example, when a line-of-sight position of the user does not exceed a predetermined movement amount for a predetermined period of time (for example, about 0.5 seconds), it is determined that the user is gazing. The predetermined period of time may be a time that can be set by the user, may be a time that is fixed and determined in advance, or may be changed depending on a distance relationship between an immediately previous line-of-sight position and a current line-of-sight position. For example, based on the detection information acquired from the line-of-sight detection circuit 165, the system control unit 50 determines that the user is gazing when a duration time of a state in which a line of sight of the user is detected at substantially the same position (state in which there is no movement of the line of sight) exceeds a predetermined period of time (threshold period). For example, when an average position of detection positions of the line of sight for a short period (≤ the above-described threshold period) including a latest detection timing falls within a predetermined range, and a variation (variance) is smaller than a predetermined value, the system control unit 50 determines that a state is the state in which there is no movement of the line of sight.

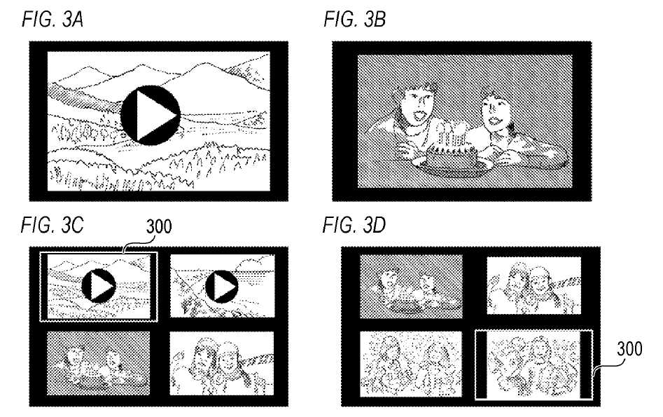

In the embodiment, the set reproduction mode can be switched between a plurality of reproduction modes including a single display mode and a multiple display mode in response to an operation (for example, an operation on the imaging mode selection button 60 in the reproduction mode) on the operation unit 70. FIGS. 3A and 3B illustrate an example of a screen in the single display mode. FIGS. 3C and 3D illustrate an example of a screen in the multiple display mode. As illustrated in FIGS. 3A and 3B, in the single display mode, only one image is displayed as a current image on the display unit 28. FIG. 3A illustrates a case where a moving image is displayed. FIG. 3B illustrates a case where a still image is displayed. As illustrated in FIGS. 3C and 3D, in the multiple display mode, a plurality of images are displayed at a time on the display unit 28. In the multiple display mode, both a still image and a moving image are displayed at a time, only a still image is displayed, or only a moving image is displayed. FIG. 3C illustrates a case where both a still image and a moving image are displayed. FIG. 3D illustrates a case where only a still image is displayed. Any of the plurality of displayed images is selected as the current image, and a selection frame 300 is displayed for the current image. Although four images are displayed in FIGS. 3C and 3D, the number of images displayed at a time in the multiple display mode is not particularly limited.

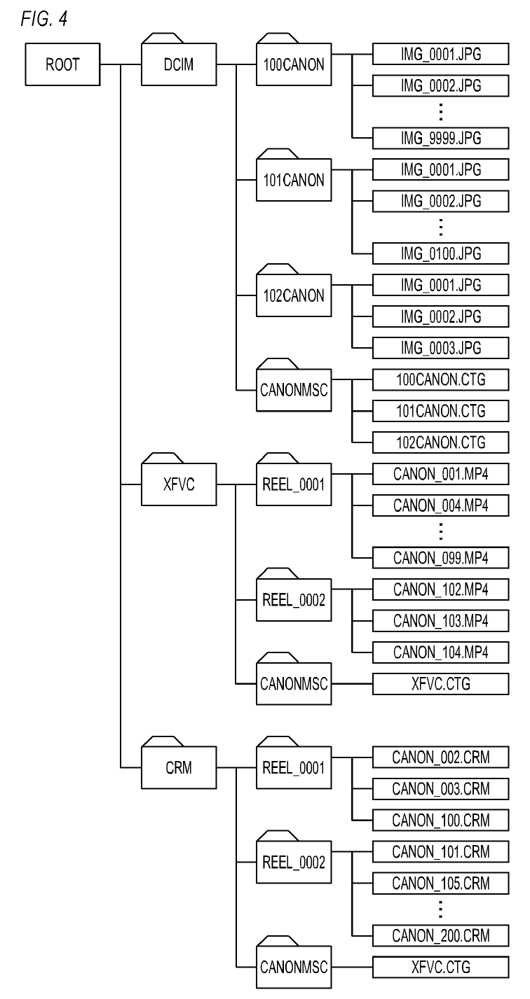

FIG. 4 illustrates an example of data stored in recording medium 200 of digital camera 100. A file name and a file format illustrated in FIG. 4 are merely exemplary, and the file name and the file format of the image to be stored are not particularly limited.

In FIG. 4, a DCIM folder is stored in the recording medium 200. A 100CANON folder, a 101CANON folder, and a 102CANON folder are stored in the DCIM folder. Still images can be stored in these folders. A still image stored in the 100CANON folder, a still image stored in the 101CANON folder, and a still image stored in the 102CANON folder are treated as separate images (separate files) even if the still images have the same file name. For example, IMG_0001.JPG stored in the 100CANON folder is treated as 100-IMG_0001.JPG. IMG_0001.JPG stored in the 101CANON folder is treated as 101-IMG_0001.JPG. IMG_0001.JPG stored in the 102CANON folder is handled as 102-IMG_0001.JPG. The number of folders in which still images can be stored can increase or decrease. For example, as a folder in which a still image can be stored, a folder that has a name in which a three-digit number and a character string “CANON” are combined is generated in the DCIM folder.

The CANONMSC folder is also stored in the DCIM folder. In the CANONMSC folder in the DCIM folder, 100CANON.CTG, 101CANON.CTG, and 102CANON.CTG are stored. 100CANON.CTG is catalog data of the 100CANON folder, 101CANON.CTG is catalog data of the 101CANON folder, and 102CANON.CTG is catalog data of the 102CANON folder. The catalog data is list data for managing images stored in the corresponding folder and includes information regarding the images.

The recording medium 200 also stores an XFVC folder. A REEL_0001 folder and a REEL_0002 folder are stored in the XFVC folder, and MP4 moving images can be stored in the folders. In the XFVC folder, a CANONMSC folder is also stored. XFVC.CTG that is catalog data of the XFVC folder is stored in the CANONMSC folder inside the XFVC folder. The XFVC.CTG may include information regarding moving images stored in all the REEL folders inside the XFVC folder or may include only information regarding moving images stored in some of the REEL folders inside the XFVC folder. For example, XFVC.CTG may include both information regarding a moving image stored in a REEL_0001 folder inside the XFVC folder and information regarding a moving image stored in a REEL_0002 folder inside the XFVC folder. XFVC.CTG may include only one of the information regarding the moving image stored in the REEL_0001 folder inside the XFVC folder and the information regarding the moving image stored in the REEL_0002 folder in the XFVC folder. The number of folders in which the MP4 moving image can be stored can increase or decrease.

A CRM folder is also stored in the recording medium 200. The REEL_0001 folder and the REEL_0002 folder are stored in the CRM folder, and a CRM moving image can be stored in these folders. In the CRM folder, a CANONMSC folder is also stored. CRM.CTG which is catalog data of the CRM folder is stored in the CANONMSC folder inside the CRM folder. CRM.CTG may include information regarding moving images stored in all the REEL folders inside the CRM folder, or may include only information regarding moving images stored in some of the REEL folders inside the CRM folder. The number of folders in which the CRM moving image can be stored can increase or decrease.

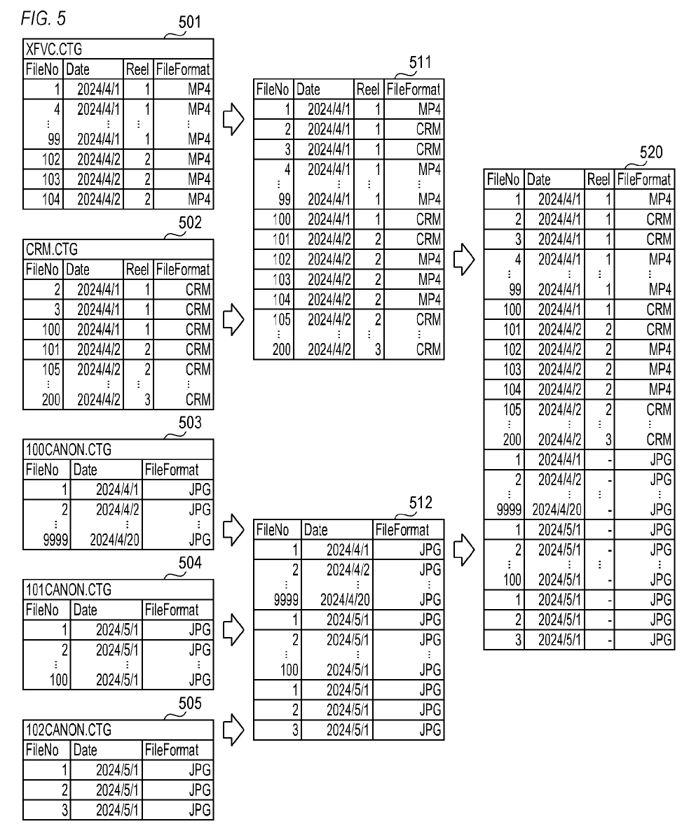

FIG. 5 illustrates an example of catalog data. For example, the system control unit 50 acquires information regarding an image (a still image or a moving image) inside the folder, and generates or updates a CTG file that is catalog data. The system control unit 50 can acquire information regarding an image inside the folder by reading the CTG file.

In the catalog data, for example, information such as a file number (FileNo), a file generation date and time (Data), and a file recording format (FileFormat) are stored. The information stored in the catalog data is not particularly limited.

FIG. 5 shows XFVC.CTG501, CRM.CTG502, 100CANON.CTG503, 101CANON.CTG504, and 102CANON.CTG505. For example, in the CRM.CTG502, the information with FileNo of 200 is information regarding CANON_200.CRM stored in REEL_0002 inside the CRM folder in FIG. 4. In 100CANON.CTG503, information regarding FileNo1 is information regarding 100-IMG_0001.JPG (IMG_0001.JPG stored in the 100CANON folder).

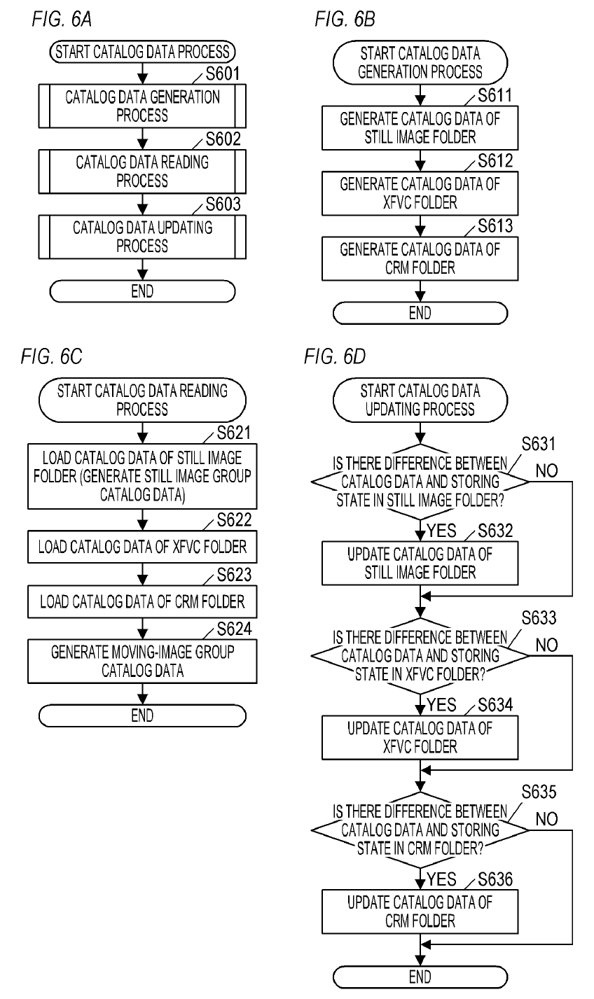

FIG. 6A is a flowchart illustrating an example of a catalog data process executed in the digital camera 100. The catalog data process of FIG. 6A is realized by the system control unit 50 by loading a program stored in the non-volatile memory 56 in the system memory 52 and executing the program. A timing at which the catalog data process of FIG. 6A is executed will be described below.

In S601, the system control unit 50 executes a catalog data generation process. In S602, the system control unit 50 executes a catalog data reading process. In S603, the system control unit 50 executes a catalog data updating process.

FIG. 6B is a flowchart illustrating an example of the catalog data generation process executed in S601 of FIG. 6A.

In S611, when a still image is stored in the DCIM folder, the system control unit 50 generates one or more pieces of catalog data corresponding to one or more still image folders (folders in which still images can be stored) stored in the DCIM folder. For example, 100CANON.CTG503, 101CANON.CTG504, and 102CANON.CTG505 in FIG. 5 are generated.

In S612, when the moving image is stored in the XFVC folder, the system control unit 50 generates catalog data of the XFVC folder. For example, XFVC.CTG501 of FIG. 5 is generated.

In S613, when the moving image is stored in the CRM folder, the system control unit 50 generates catalog data of the CRM folder. For example, CRM.CTG502 of FIG. 5 is generated.

In S611 and S612, when there is catalog data that has the same name as the catalog data to be generated, the generation of the catalog data is not executed.

FIG. 6C is a flowchart illustrating an example of the catalog data reading process executed in S602 of FIG. 6A.

In S621, the system control unit 50 reads all the catalog data stored in the DCIM folder (the CANONMSC folder in the DCIM folder) and loads the read data in the memory 32 as one piece of still-image group catalog data. Accordingly, for example, the catalog data 512 of FIG. 5 is obtained. The catalog data 512 has a configuration in which 100CANON.CTG503, 101CANON.CTG504, and 102CANON.CTG505 are connected in this order.

In S622, the system control unit 50 reads the catalog data stored in the XFVC folder (the CANONMSC folder in the XFVC folder) and loads the catalog data in the memory 32.

In S623, the system control unit 50 reads the catalog data stored in the CRM folder (the CANONMSC folder inside the CRM folder) and loads the catalog data in the memory 32.

In S624, the system control unit 50 combines the two pieces of catalog data loaded in S622 and S623 into one piece of moving-image group catalog data. In the XFVC folder and the CRM folder, moving images are stored so that file names (FileNo) do not overlap. In S624, the catalog data in which information regarding the moving image is rearranged in a FileNo order is obtained. For example, the catalog data 511 of FIG. 5 is obtained.

FIG. 6D is a flowchart illustrating an example of the catalog data updating process executed in S603 of FIG. 6A.

In S631, the system control unit 50 determines whether there is a difference between the still image indicated by the catalog data stored in the DCIM folder and the still image stored in the DCIM folder. When there is the difference, the process proceeds to S532. Otherwise, the process proceeds to S633.

In S632, the system control unit 50 updates the catalog data loaded in S621 of FIG. 6C and the catalog data in which the difference is detected in S631 among the catalog data stored in the DCIM folder.

In S633, the system control unit 50 determines whether there is a difference between the MP4 moving image indicated by the catalog data stored in the XFVC folder and the MP4 moving image stored in the XFVC folder. When there is the difference, the process proceeds to S634. Otherwise, the process proceeds to S635.

In S634, the system control unit 50 updates the catalog data loaded in S622 of FIG. 6C and the catalog data stored in the XFVC folder.

In S635, the system control unit 50 determines whether there is a difference between the CRM moving image indicated by the catalog data stored in the CRM folder and the MP4 moving image stored in the CRM folder. When there is the difference, the process proceeds to S636. Otherwise, the catalog data updating process of FIG. 6D ends.

In S636, the system control unit 50 updates the catalog data loaded in S623 of FIG. 6C and the catalog data stored in the CRM folder.

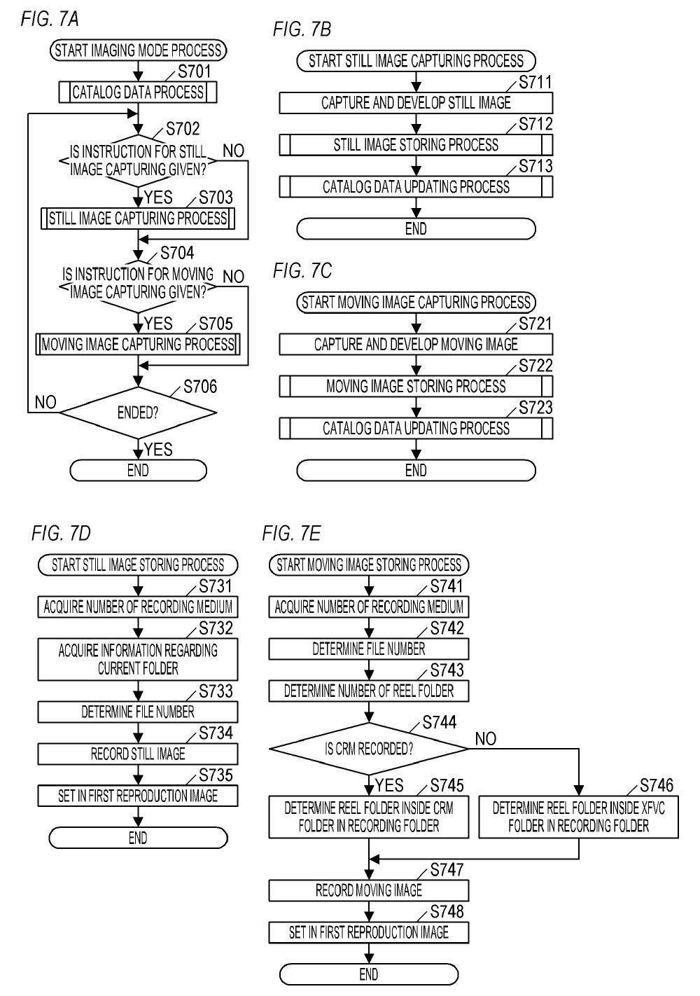

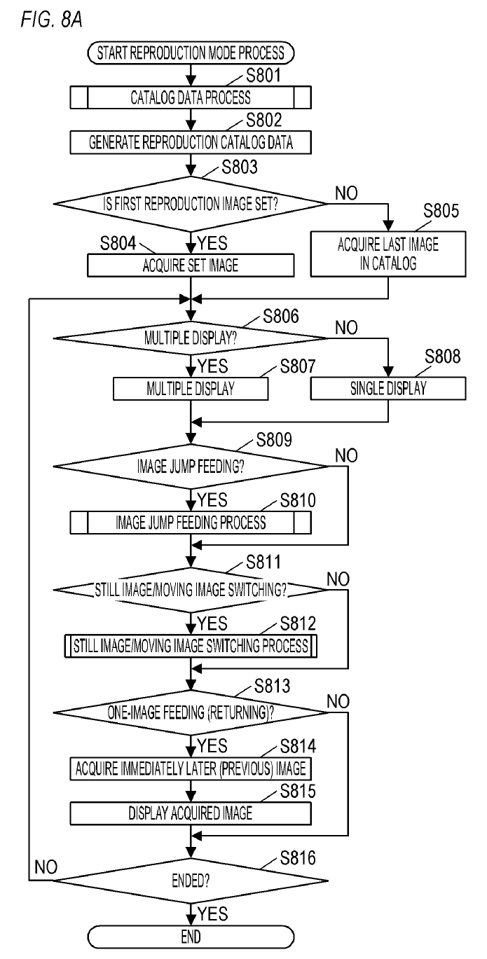

FIG. 7A is a flowchart illustrating an example of the imaging mode process executed by the digital camera 100. The imaging mode process of FIG. 7A is realized by the system control unit 50 by loading a program stored in the non-volatile memory 56 in the system memory 52 and executing the program. For example, when the imaging mode is set, the system control unit 50 starts the imaging mode process of FIG. 7A.

In S701, the system control unit 50 executes the catalog data process of FIG. 6A. A timing at which the catalog data process is executed is not limited thereto. For example, the catalog data process may be executed when a reproduction mode is set or may be executed when the digital camera 100 is started.

In step S702, the system control unit 50 determines whether the shutter button 61 has been operated and an instruction to execute still image capturing has been given. When the instruction to execute the still image capturing has been given, the process proceeds to S703. Otherwise, the process proceeds to S704.

In step S703, the system control unit 50 executes a still image capturing process. Details of the still image capturing process will be described below with reference to FIG. 7B.

In S704, the system control unit 50 determines whether the moving image button 76 has been operated and an instruction to execute moving image capturing has been given. When the instruction to execute moving image capturing has been given, the process proceeds to S705. Otherwise, the process proceeds to S706.

In S705, the system control unit 50 executes a moving image capturing process. Details of the moving image capturing process will be described below with reference to FIG. 7C.

In S706, the system control unit 50 determines whether an end condition of the imaging mode process of FIG. 7A is satisfied. When the end condition is satisfied, the imaging mode process is ended. Otherwise, the process proceeds to S702. The end condition is, for example, a condition that an instruction to power off the digital camera 100 has been given or a condition that an instruction to cancel the setting of the imaging mode (switching to another mode such as the reproduction mode) has been given.

FIG. 7B is a flowchart illustrating an example of the still image capturing process executed in step S703 in FIG. 7A.

In S711, the system control unit 50 controls the imaging unit 22, the image processing unit 24, and the like to capture and develop a still image. Image processes other than development may be further executed.

In step S712, the system control unit 50 executes a still image storing process of storing the still image obtained in step S711. Details of the still image storing process will be described below with reference to FIG. 7D.

In S713, the system control unit 50 executes the catalog data updating process of FIG. 6D.

FIG. 7C is a flowchart illustrating an example of the moving image capturing process executed in S705 of FIG. 7A.

In S721, the system control unit 50 controls the imaging unit 22, the image processing unit 24, and the like to capture and develop a moving image. Image processes other than development may be further executed.

In S722, the system control unit 50 executes a moving image storing process of storing the moving image obtained in S721. Details of the moving image storing process will be described below with reference to FIG. 7E.

In S723, the system control unit 50 executes the catalog data updating process of FIG. 6D.

FIG. 7D is a flowchart illustrating an example of the still image storing process executed in step S712 in FIG. 7B.

In S731, the system control unit 50 acquires a number with which a recording medium (for example, the recording medium 200) on which a still image is recorded (stored) can uniquely be identified. In the embodiment, it is assumed that a plurality of recording media can be connected to the digital camera 100, and a still image is recorded on the recording medium that has the number acquired in S731.

In S732, the system control unit 50 acquires information regarding a current folder that is a folder in which still images are recorded (a still image folder (a folder in which still images can be stored) in the DCIM folder). The information regarding the current folder is a folder number that is a number used for the name of the current folder. For example, the system control unit 50 selects the latest still image folder or a still image folder selected by the user as the current folder. When the number of still images that can be stored in the still image folder has an upper limit and the number of still images stored in the current folder reaches the upper limit, the system control unit 50 generates a new still image folder and selects the folder as the current folder.

In step S733, the system control unit 50 determines a file number of a still image to be recorded. For example, the system control unit 50 determines a number obtained by adding 1 to the file number of the latest still image stored in the current folder as the file number of the still image to be recorded.

In S734, the system control unit 50 records the still image in the current folder in the recording medium (in the embodiment, the recording medium 200 is used) corresponding to the information acquired in S731 with the file name of the file number determined in S733.

In step S735, the system control unit 50 sets the still image recorded in step S734 as an image to be displayed first in the reproduction mode. When the image to be displayed first in the reproduction mode is set, the image to be displayed first in the reproduction mode is updated.

FIG. 7E is a flowchart illustrating an example of the moving image storing process executed in S722 of FIG. 7C.

In S741, the system control unit 50 acquires a number with which the recording medium (for example, the recording medium 200) on which the moving image is recorded (stored) can be uniquely specified.

In S742, the system control unit 50 determines a file number of a moving image to be recorded. For example, the system control unit 50 determines, as the file number of the moving image to be recorded, a number obtained by adding 1 to the file number of the latest moving image in the moving image group including the moving image stored in the CRM folder and the moving image stored in the XFVC folder.

In S743, the system control unit 50 determines the number of the REEL folder (the REEL folder in the CRM folder or the XFVC folder) in which the moving image is recorded. The number of the REEL folder is a folder number (REEL number) that is a number used for the name of the REEL folder. For example, the system control unit 50 selects a latest REEL folder in a folder to be used between the CRM folder and the XFVC folder or the REEL folder selected by the user as the REEL folder in which the moving image is recorded.

In S744, the system control unit 50 determines whether a CRM moving image is recorded. When the CRM moving image is recorded, the process proceeds to S745. When the CRM moving image is not recorded (when a MP4 moving image is recorded), the process proceeds to S746. For example, the system control unit 50 selects (switches) a file format of the moving image in response to an instruction from the user, and records the moving image in the selected file format.

In S745, the system control unit 50 determines the REEL folder that has the number acquired in S743 in the CRM folder as the REEL folder in which the moving image is recorded.

In S746, the system control unit 50 determines the REEL folder that has the number acquired in S743 in the XFVC folder as the REEL folder in which the moving image is recorded.

In S747, the system control unit 50 stores the moving image in the REEL folder determined in S745 or S746 in the recording medium (in the embodiment, the recording medium 200 is used) corresponding to the information acquired in S741 with the file name of the file number determined in S742.

In S748, the system control unit 50 sets the moving image recorded in S747 as an image to be displayed first in the reproduction mode. When the image to be displayed first in the reproduction mode is set, the image to be displayed first in the reproduction mode is updated.

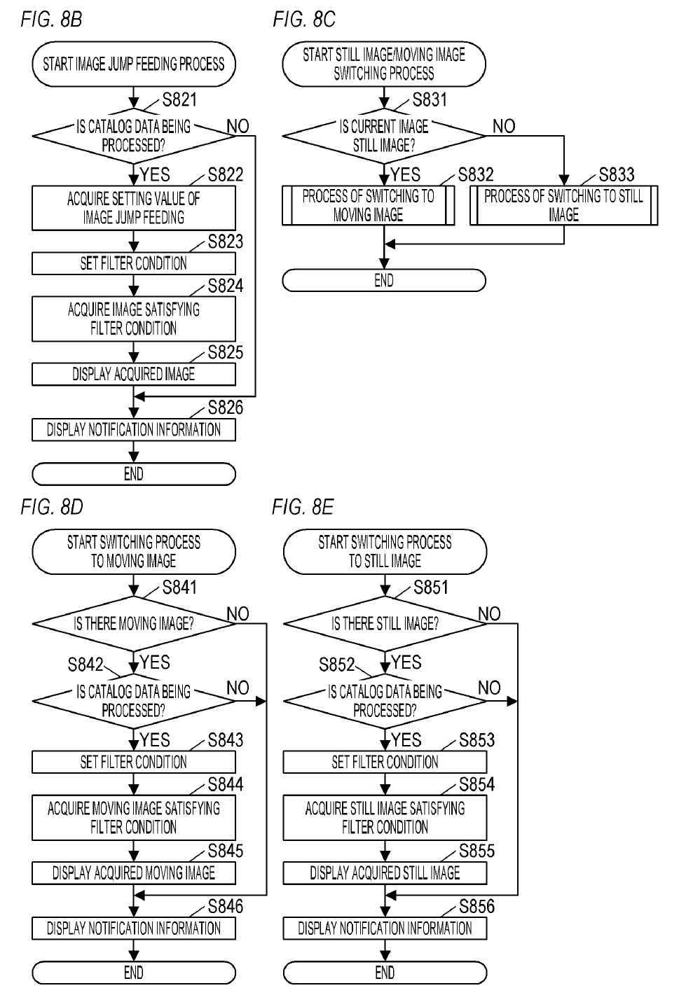

FIG. 8A is a flowchart illustrating an example of the reproduction mode process executed by the digital camera 100. The reproduction mode process of FIG. 8A is realized by the system control unit 50 by loading a program stored in the non-volatile memory 56 in the system memory 52 and executing the program. For example, when the reproduction mode is set, the system control unit 50 starts the reproduction mode process of FIG. 8A.

In S801, the system control unit 50 executes the catalog data process of FIG. 6A.

In S802, the system control unit 50 combines the still-image group catalog data and the moving-image group catalog data loaded in the memory 32 into one piece of reproduction catalog data. The reproduction catalog data indicates information regarding images in a predetermined reproduction order in the digital camera 100. A timing at which the process of S802 is executed is not limited thereto. For example, the process of S802 may be executed when the digital camera 100 is started.

In S802, for example, the catalog data 520 of FIG. 5 is obtained as the reproduction catalog data. The catalog data 520 has a configuration in which moving-image group catalog data after the still-image group catalog data is connected. Therefore, in the catalog data 520, information regarding moving image groups stored in a plurality of moving image folders is arranged in a certain order, and then information regarding still image groups stored in a plurality of still image folders is arranged in a certain order. The moving image folder is a folder in which a moving image can be stored, and is the above-described REEL folder. The still image folder is a folder in which a still image can be stored, and is 100CANON folder, 101CANON folder, and 102CANON folder described above.

The catalog data 520 may have a configuration in which still-image group catalog data before the moving-image group catalog data is connected. That is, in the catalog data 520, before information regarding image groups (moving image groups) stored in a plurality of moving image folders is arranged in a certain order, information regarding image groups (still image groups) stored in a plurality of still image folders may be arranged in a certain order.

In S803, the system control unit 50 determines whether an image to be displayed first in the reproduction mode has been set. When the image to be displayed first in the reproduction mode is set, the process proceeds to S804. Otherwise, the process proceeds to S805. When the still image capturing or the moving image capturing is executed, an image to be displayed first in the reproduction mode is set in S735 of FIG. 7D or S748 of FIG. 7E. Thereafter, when the image to be displayed first in the reproduction mode is not deleted, it is determined that the image to be displayed first in the reproduction mode has been set. The setting of an image to be displayed first in the reproduction mode may be canceled through an initialization process when the digital camera 100 is started.

In S804, the system control unit 50 acquires the image set as the image to be displayed first in the reproduction mode as the current image from the recording medium 200.

In S805, the system control unit 50 acquires the image indicated last in the reproduction catalog data obtained in S802 as the current image from the recording medium 200.

In S806, the system control unit 50 determines whether the set reproduction mode is the multiple display mode. In the case of the multiple display mode, the process proceeds to S807. Otherwise (in the case of the single display mode), the process proceeds to S808.

In S807, the system control unit 50 displays a screen in the multiple display mode in which a plurality of images including the current image acquired in S804 or S805 are arranged on the display unit 28. Of the plurality of images to be displayed, an image other than the current image may be acquired in S804 or S805 or may be acquired in S807.

In S808, the system control unit 50 displays a screen in the single display mode in which the current image acquired in S804 or S805 is arranged on the display unit 28.

In step S809, the system control unit 50 determines whether the main electronic dial 71 is operated and an instruction for image jump feeding is given. When the instruction for image jump feeding is given, the process proceeds to S810. Otherwise, the process proceeds to S811. The image jump feeding is a function of switching the current image to an image satisfying a specific condition. The specific condition may be a condition determined in advance by a manufacturer or the like or may be a condition designated by the user. The specific condition may be, for example, a condition of an image in a folder different from the folder of the current image that is being displayed as in the condition described in Japanese Patent Laid-Open No. 2007-53414. The specific condition may be a condition for switching the current image only between a plurality of still images, or a condition for switching the current image only between a plurality of moving images.

In S810, the system control unit 50 executes an image jump feeding process. Details of the image jump feeding process will be described below with reference to FIG. 8B.

In S811, the system control unit 50 determines whether the imaging mode selection button 60 has been operated and an instruction to switch between a still image and a moving image has been given. The switching between a still image and a moving image means switching the current image from a still image to a moving image or from a moving image to a still image. When an instruction to switch between the still image and the moving image is given, the process proceeds to S812. Otherwise, the process proceeds to S813. The imaging mode selection button 60 is a button for switching the imaging mode. However, since it is not necessary to switch the imaging mode in the reproduction mode, in the embodiment, the imaging mode selection button 60 functions as a button for giving an instruction to switch between a still image and a moving image in the reproduction mode.

In S812, the system control unit 50 executes a switching process between a still image and a moving image. Details of the process of switching between a still image and a moving image will be described below with reference to FIG. 8C.

In step S813, the system control unit 50 determines whether a right button or a left button of the four-direction key 74 has been operated to give an instruction to feed one image or return one image. The instruction to feed one image is given through an operation of the right button, and the instruction to return one image is given through an operation of the left button. When the instruction to feed one image or return one image is given, the process proceeds to S814. Otherwise, the process proceeds to S815.

In S814, the system control unit 50 acquires an image immediately after or immediately before the current image displayed on the display unit 28 in the reproduction order indicated by the reproduction catalog data from the recording medium 200 as a new current image. In the case of one-image feeding, an image immediately after the current image displayed on the display unit 28 is acquired as the new current image. In the case of one-image returning, an image immediately before the current image displayed on the display unit 28 is acquired as the new current image. When the instruction to feed one image to return one image is repeatedly given, the current image is switched in the reproduction order indicated by the reproduction catalog data. The image immediately after the image indicated last in the reproduction catalog data is the image indicated first in the reproduction catalog data, and the image immediately before the image indicated first in the reproduction catalog data is the image indicated last in the reproduction catalog data.

In S815, the system control unit 50 displays the current image acquired in S814 on the display unit 28. In the case of the multiple display mode, images other than the current image to be displayed may be switched in response to the switching of the current image.

In S816, the system control unit 50 determines whether the end condition of the reproduction mode process of FIG. 8A is satisfied. When the end condition is satisfied, the reproduction mode process ends. Otherwise, the process proceeds to S806. The end condition is, for example, a condition that an instruction to power off the digital camera 100 has been given, or a condition that an instruction to cancel the setting of the reproduction mode (switch to another mode such as the imaging mode) has been given.

FIG. 8B is a flowchart illustrating an example of the image jump process executed in S810 of FIG. 8A.

In S821, the system control unit 50 determines whether the catalog data has been loaded (written) in the memory 32 or the catalog data loaded in the memory 32 has been updated. When the catalog data is loaded or updated, the image jump process of FIG. 8B ends. Otherwise, the process proceeds to S822.

In S822, the system control unit 50 acquires a setting value of the image jump feeding. The setting value is, for example, a value designated by the user to designate a condition of the image jump feeding.

In S823, the system control unit 50 sets a condition (filter condition) for searching for a new current in accordance with the setting value acquired in S822.

In S824, the system control unit 50 acquires an image satisfying the filter condition set in S823 from the recording medium 200 as a new current image with reference to the reproduction catalog data.

In S825, the system control unit 50 displays the current image acquired in S824 on the display unit 28.

In S826, the system control unit 50 displays notification information indicating completion of the image jump feeding on the display unit 28 for a predetermined time.

FIG. 8C is a flowchart illustrating an example of the process of switching between the still image and the moving image executed in step S812 in FIG. 8A.

In S831, the system control unit 50 determines whether the current image displayed on the display unit 28 is a still image in the DCIM folder. When the current image is a still image, the process proceeds to S832. When the current image is not a still image (when the current image is a moving image), the process proceeds to S833.

In S832, the system control unit 50 executes the switching process from a still image to a moving image. Details of the process of switching from a still image to a moving image will be described below with reference to FIG. 8D.

In S833, the system control unit 50 executes the switching process from a moving image to a still image. Details of the process of switching from a moving image to a still image will be described below with reference to FIG. 8E.

FIG. 8D is a flowchart illustrating an example of the process of switching from a still image to a moving image executed in step S832 in FIG. 8C.

In S841, the system control unit 50 determines whether a moving image is stored in the recording medium 200 with reference to the reproduction catalog data. When the moving image is stored, the process proceeds to S842. Otherwise, the process proceeds to S846.

In S842, the system control unit 50 determines whether the catalog data has been loaded (written) in the memory 32 or the catalog data loaded in the memory 32 has been updated. When the catalog data is loaded or updated, the process proceeds to S846. Otherwise, the process proceeds to S843.

In S843, the system control unit 50 sets a condition (filter condition) that the moving image is the moving image indicated last in the moving image group indicated in the reproduction catalog data. The filter condition is not limited thereto. Examples of other filter conditions will be described below.

In S844, the system control unit 50 acquires a moving image satisfying the filter condition set in S843 from the recording medium 200 as a new current image with reference to the reproduction catalog data. When the catalog data 520 of FIG. 5 is referred to, CANON_200.CRM is acquired as the new current image.

In S845, the system control unit 50 displays the current image acquired in S844 on the display unit 28.

In S846, the system control unit 50 displays the predetermined notification information on the display unit 28 for a predetermined time. When the processes of S843 to S845 are executed, notification information indicating completion of the switching of the current image is displayed. Otherwise, notification information indicating that the switching of the current image has not been executed is displayed.

FIG. 8E is a flowchart illustrating an example of the process of switching from the moving image to the still image executed in step S833 in FIG. 8C.

In S851, the system control unit 50 determines whether a still image is stored in the recording medium 200 with reference to the reproduction catalog data. When the still image is stored, the process proceeds to S852. Otherwise, the process proceeds to S856.

In S852, the system control unit 50 determines whether the catalog data has been loaded (written) in the memory 32 or the catalog data loaded in the memory 32 has been updated. When the catalog data is loaded or updated, the process proceeds to S856. Otherwise, the process proceeds to S853.

In step S853, the system control unit 50 sets a condition (filter condition) that the image is the still image indicated last in the still image group indicated in the reproduction catalog data. The filter condition is not limited thereto. Examples of other filter conditions will be described below. As the filter condition in the process of switching from a moving image to a still image, a condition different from the filter condition in the process of switching from a still image to a moving image may be set.

In S854, the system control unit 50 acquires a still image satisfying the filter condition set in S853 from the recording medium 200 as a new current image with reference to the reproduction catalog data. When the catalog data 520 of FIG. 5 is referred to, 102-IMG_0003.JPG is acquired as a new current image.

In S855, the system control unit 50 displays the current image acquired in S854 on the display unit 28.

In S856, the system control unit 50 displays the predetermined notification information on the display unit 28 for a predetermined time. When the processes of S853 to S855 are executed, the notification information indicating completion of the switching of the current image is displayed. Otherwise, notification information indicating that the switching of the current image has not been executed is displayed.

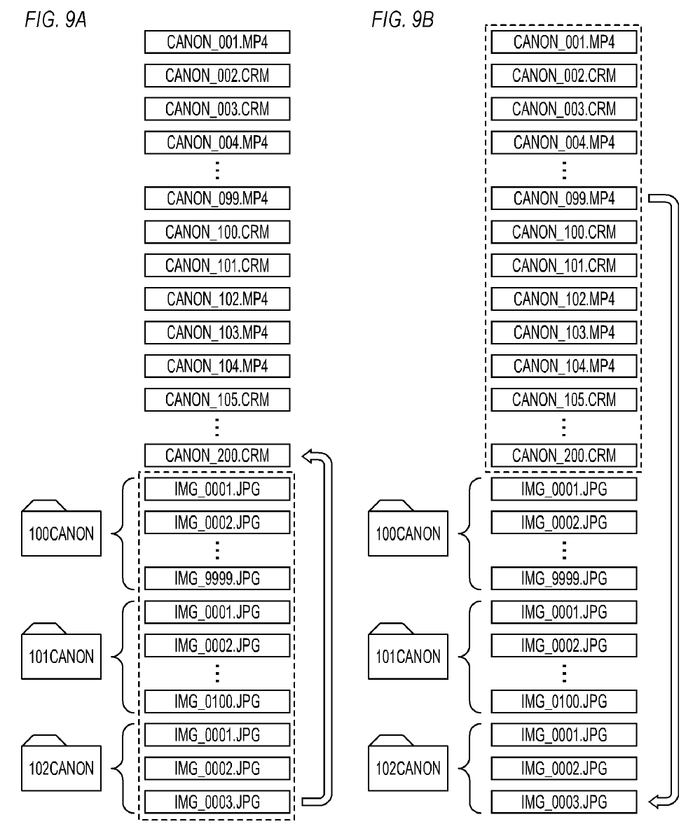

FIG. 9A illustrates an example in which the current image is switched from the still image to the moving image when the filter condition set in S832 of FIG. 8C (S843 of FIG. 8D) is the condition that the moving image is the moving image indicated last in the moving image group indicated in the reproduction catalog data. In FIG. 9A, the moving image indicated last is CANON_200.CRM. Therefore, as indicated by an arrow, when the current image is 102-IMG_0002.JPG, the current image is switched to CANON_200.CRM through the process of S832 of FIG. 8C (S844 of FIG. 8D). Even when one of the still image groups surrounded by the broken lines is the current image, the current image is switched to CANON_200.CRM through the process of S832 in FIG. 8C.

FIG. 9B illustrates an example in which the current image is switched from the moving image to the still image when the filter condition set in S833 of FIG. 8C (S853 in FIG. 8E) is the condition that the still image is the still image indicated last in the still image group indicated in the reproduction catalog data. In FIG. 9B, the last indicated still image is 102-IMG_0003.JPG. Therefore, as indicated by the arrow, when the current image is CANON_099.MP4, the current image is switched to 102-IMG_0003.JPG through the process of S833 (S854 in FIG. 8E) in FIG. 8C. Even when one of the moving image groups surrounded by the broken lines is the current image, the current image is switched to 102-IMG_0003.JPG through the process of S833 in FIG. 8C.

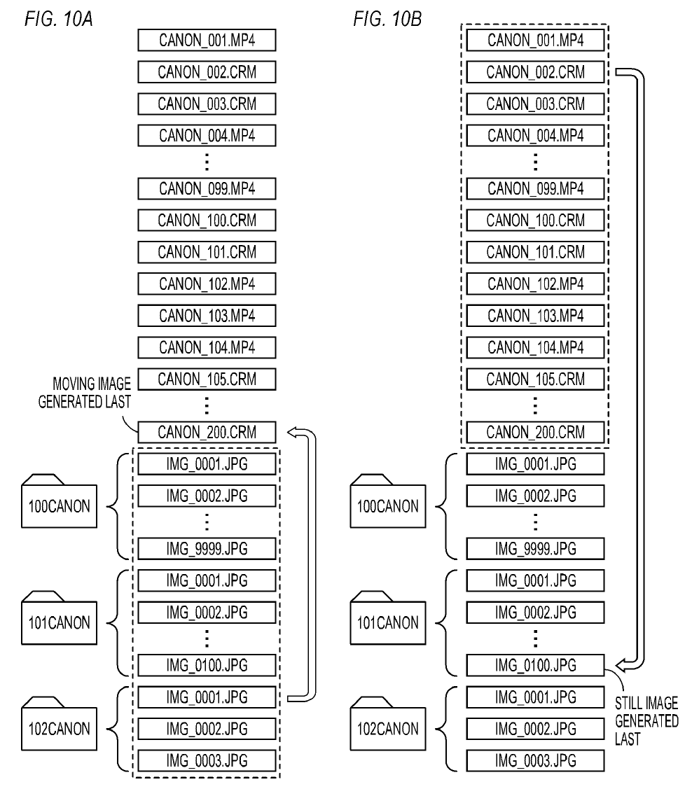

FIG. 10A illustrates an example in which the current image is switched from a still image to a moving image when the filter condition set in S832 of FIG. 8C (S843 of FIG. 8D) is a condition that the moving image is the moving image generated last in the moving image group indicated in the reproduction catalog data. The last generated moving image may be interpreted as a moving image of which an imaging date and time is the latest. In FIG. 10A, the last generated moving image is CANON_200.CRM. Therefore, as indicated by the arrow, when the current image is 102-IMG_0001.JPG, the current image is switched to CANON_200.CRM through the process of S832 of FIG. 8C (S844 of FIG. 8D). Even when one of the still image groups surrounded by the broken lines is the current image, the current image is switched to CANON_200.CRM through the process of S832 in FIG. 8C.

FIG. 10B illustrates an example in which the current image is switched from the moving image to the still image when the filter condition set in S833 of FIG. 8C (S853 of FIG. 8E) is the condition that the still image is the still image generated last in the still image group indicated in the reproduction catalog data. The last generated still image may be interpreted as a still image of which an imaging date and time is the latest. In FIG. 10B, the last generated still image is 101-IMG_0100.JPG. Therefore, as indicated by an arrow, when the current image is CANON_002.CRM, the current image is switched to 101-IMG_0100.JPG through the process of S833 of FIG. 8C (S854 of FIG. 8E). Even when one of the moving image groups surrounded by the broken lines is the current image, the current image is switched to 101-IMG_0100.JPG through the process of S833 in FIG. 8C.

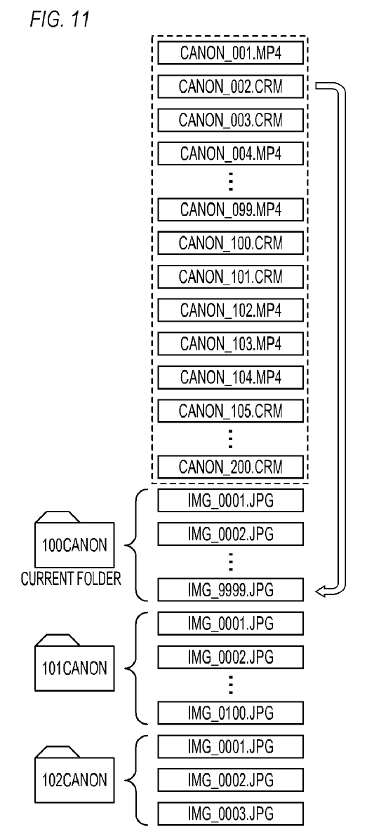

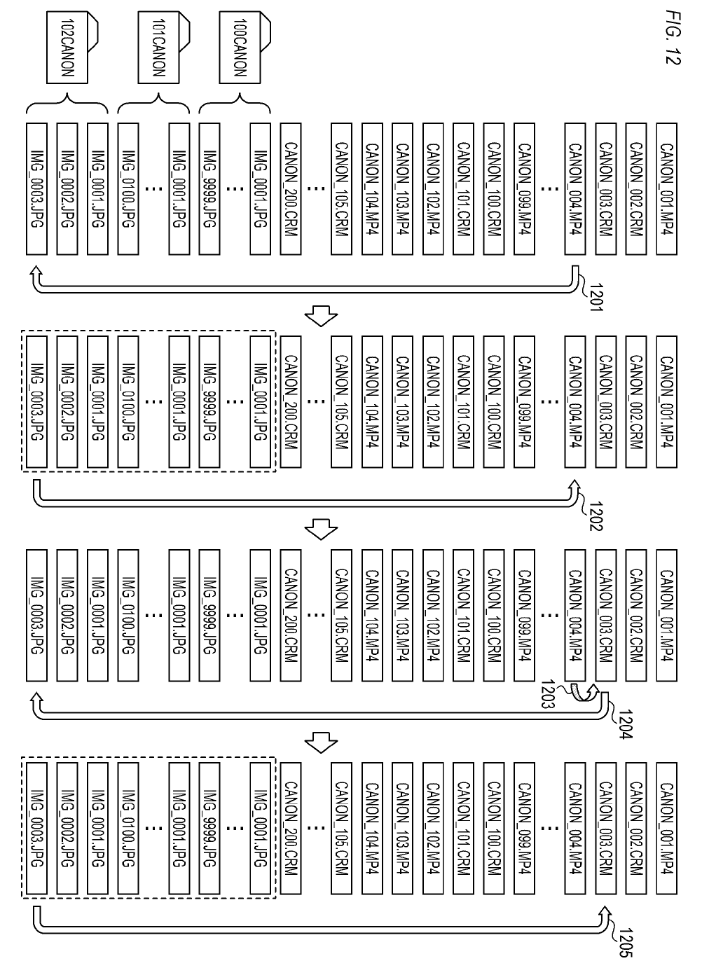

FIG. 11 illustrates an example in which the current image is switched from the moving image to the still image when the filter condition set in S833 of FIG. 8C (S853 of FIG. 8E) is the condition that is the still image is the still image generated last in the still image group stored in the current folder. In FIG. 11, the current folder is a 100CANON folder, and the last generated still image in the still image group stored in the current folder is 100-IMG_9999.JPG. Therefore, as indicated by an arrow, when the current image is CANON_002.CRM, the current image is switched to 100-IMG_9999.JPG through the process of S833 of FIG. 8C (S854 of FIG. 8E). Even when one of the moving image groups surrounded by the broken lines is the current image, the current image is switched to 100-IMG_9999.JPG through the process of S833 in FIG. 8C.

In the embodiment, one of the plurality of still image folders is selected as the current folder, but one of the plurality of moving image folders may be selected as the current folder. In this case, a condition that the moving image is the last generated moving image in the moving image group stored in the current folder may be used as the filter condition set in S832 of FIG. 8C (S843 of FIG. 8D).

FIG. 12 illustrates an example of transition of the current image. In FIG. 12, the filter condition set in S832 of FIG. 8C (S843 of FIG. 8D) is a condition that the moving image is the last displayed moving image in the moving image group indicated in the reproduction catalog data. The filter condition set in step S833 in FIG. 8C (step S853 in FIG. 8E) is a condition that the still image is the still image indicated last in the group of still images indicated in the reproduction catalog data. The last indicated still image is 102-IMG_0003.JPG.

It is assumed that the imaging mode selection button 60 is pressed with the current image being CANON_004.MP4. In this case, as indicated by an arrow 1201, the current image is switched to 102-IMG_0003.JPG through the process of S833 of FIG. 8C (S854 of FIG. 8E). At that time, the system control unit 50 stores information regarding CANON_004.MP4 that is the current image before the switching (the moving image displayed last) in the memory 32.

Subsequently, it is assumed that the imaging mode selection button 60 is pressed with the current image being 102-IMG_0003.JPG. In this case, referring to the information stored in memory 32 through the process of S832 (S844 in FIG. 8D) in FIG. 8C, the current image is switched to CANON_004.MP4 as indicated by arrow 1202. Even when one of the still image groups surrounded by the broken lines is the current image, the current image is switched to CANON_004.MP4 through the process of S832 in FIG. 8C.

Subsequently, it is assumed that, the left button of the four-direction key 74 is pressed with the current image being CANON_004.MP4 and the current image is switched to CANON_003.MP4 as indicated by an arrow 1203 (one image is returned). Thereafter, it is assumed that the imaging mode selection button 60 is pressed with the current image being CANON_003.MP4. In this case, as indicated by an arrow 1204, the current image is switched to 102-IMG_0003.JPG through the process of S833 of FIG. 8C (S854 of FIG. 8E). At that time, the system control unit 50 stores information regarding CANON_003.MP4 that is the current image before the switching (the moving image displayed last) in the memory 32.

The process of switching the current image to another moving image before the pressing operation using the imaging mode selection button 60 may be a process of feeding one image or an image jump feeding process.

Subsequently, it is assumed that the imaging mode selection button 60 is pressed with the current image being 102-IMG_0003.JPG. In this case, referring to the information stored in memory 32 through the process of S832 (S844 in FIG. 8D) in FIG. 8C, the current image is switched to CANON_003.MP4 as indicated by arrow 1205. Even when one of the still image groups surrounded by the broken lines is the current image, the current image is switched to CANON_003.MP4 through the process of S832 in FIG. 8C.

The filter condition set in step S833 in FIG. 8C (step S853 in FIG. 8E) may be a condition that the still image is the still image displayed last in the still image group indicated in the reproduction catalog data.

The filter conditions described with reference to FIGS. 9A to 12 can be used in both the single display mode and the multiple display mode. In the case of the multiple display mode, on the condition that the image is the last displayed image (the moving image or the still image), the last displayed image may be the current image before the switching or may not be the current image before the switching.

As described above, according to the embodiment, an image to be displayed is switched between a still image and a moving image in response to a predetermined user operation. In this way, it is possible to reduce the user's labor for confirming the image. For example, when a moving image and a still image are managed in different folders, it is possible to easily confirm both the still image and the moving image after executing one of still image capturing and moving image capturing and then executing the other.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment. For example, although the example in which a captured image is displayed has been described, the present disclosure is also applicable to a case in which another image such as a computer graphic (CG) image is displayed. The operation members for various processes are not limited to the above-described members. For example, the operation member for switching between a still image and a moving image may be a specific operation unit different from the imaging mode selection button 60. The specific operation unit may be a graphical user interface (GUI) button or the like displayed on the display unit 28.

Furthermore, in the above-described embodiment, the case where the present disclosure is applied to a digital camera has been described as an example, but the present disclosure is not limited to this example, and any electronic device capable of executing display control of an image stored in a storage unit can be applied. For example, the present disclosure is applicable to a personal computer, a PDA, a mobile phone terminal, a portable image viewer, a printer apparatus, a digital photo frame, a music player, a video game machine, an electronic book reader, and the like. The present disclosure is further applicable to, for example, a video player, a display device (including a projector), a tablet terminal, a smartphone, an AI speaker, a home electrical appliance, an on-vehicle apparatus, and the like.

According to the present disclosure, it is possible to reduce a user's labor for confirming an image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-103940, filed June 27, 2024, which is hereby incorporated by reference herein in its entirety.

What is claimed is:

1. An electronic device comprising:
a processor; and
a memory storing a program which, when executed by the processor, causes an electronic device to execute a control process of performing control to display an image stored in a storage on a display,
wherein, in a case where a first user operation of switching an image to be displayed on the display is executed with a still image being displayed on the display, an image to be displayed on the display is switched from the still image to a moving image in the control process, and
wherein, in a case where the first user operation is executed with a moving image being displayed on the display, the image to be displayed on the display is switched from the moving image to a still image in the control process.

2. The electronic device according to claim 1,
wherein, in a case where the first user operation is executed with a still image being displayed on the display, the image to be displayed on the display is switched from the still image to a moving image satisfying a first condition in the control process, and
wherein, in a case where the first user operation is executed with a moving image being displayed on the display, the image to be displayed on the display is switched from the moving image to a still image satisfying a second condition in the control process.

3. The electronic device according to claim 2,
wherein images stored in the storage are managed in a list, and
wherein the first condition is a condition that the moving image is a moving image indicated last among moving images indicated in the list.

4. The electronic device according to claim 2,
wherein the first condition is a condition that the moving image is a moving image generated last among moving images stored in the storage.

5. The electronic device according to claim 2,
wherein the storage stores a plurality of folders that is able to store moving images,
wherein one of the plurality of folders is selected in the control process, and
wherein the first condition is a condition that the moving image is a moving image generated last among moving images stored in the selected folder.

6. The electronic device according to claim 2,
wherein the first condition is a condition that the moving image is a moving image displayed last among moving images stored in the storage.

7. The electronic device according to claim 2,
wherein images stored in the storage are managed in a list, and
wherein the second condition is a condition that the still image is a still image indicated last among still images indicated in the list.

8. The electronic device according to claim 2,
wherein the second condition is a condition that the still image is a still image generated last among still images stored in the storage.

9. The electronic device according to claim 2,
wherein the storage stores a plurality of folders that is able to store still images,
wherein one of the plurality of folders is selected in the control process, and
wherein the second condition is a condition that the still image is a still image generated last among still images stored in the selected folder.

10. The electronic device according to claim 2,
wherein the second condition is a condition that the still image is a still image displayed last among still images stored in the storage.

11. The electronic device according to claim 1,
wherein in the control process, the image to be displayed on the display is switched in a predetermined reproduction order in response to a second user operation of switching the image to be displayed on the display.

12. The electronic device according to claim 11,
wherein the storage stores a plurality of first folders that are able to store still images and a plurality of second folders that are able to store moving images, and
wherein the predetermined reproduction order is a reproduction order in which image groups of the plurality of first folders are arranged in a first order, and in which image groups of the plurality of second folders are arranged in a second order before or after the image groups of the plurality of first folders.

13. The electronic device according to claim 1,
wherein the first user operation is a pressing operation on a specific operation member.

14. The electronic device according to claim 13,
wherein the electronic device is an imaging device that has an imaging mode and a reproduction mode,
wherein the specific operation member is an operation member for switching a set imaging mode among a plurality of imaging modes, and
wherein, in the control process, control is performed such that the image to be displayed on the display is switched in response to the pressing operation on the specific operation member in the reproduction mode.

15. A control method of an electronic device, comprising:
performing control to display an image stored in a storage on a display;
in a case where a first user operation of switching an image to be displayed on the display is executed with a still image being displayed on the display, switching an image to be displayed on the display from the still image to a moving image; and
in a case where the first user operation is executed with a moving image being displayed on the display, switching the image to be displayed on the display from the moving image to a still image.

16. A non-transitory computer readable medium that stores a program, wherein the program causes a computer to execute a control method of an electronic device, the control method comprising:
performing control to display an image stored in a storage on a display;
in a case where a first user operation of switching an image to be displayed on the display is executed with a still image being displayed on the display, switching an image to be displayed on the display from the still image to a moving image; and
in a case where the first user operation is executed with a moving image being displayed on the display, switching the image to be displayed on the display from the moving image to a still image.
